(19) United States
(12) Patent Application Publication
(10) Pub. No.: US 2013/0303316 A1
(43) Pub. Date: Nov. 14, 2013

(54) BELT-DRIVEN CONTINUOUSLY VARIABLE TRANSMISSION

(71) Applicants: Toshinari Sano, Gotemba-shi (JP); Akira Ijichi, Susono-shi (JP); Tatsuya Saito, Susono-shi (JP)

(72) Inventors: Toshinari Sano, Gotemba-shi (JP); Akira Ijichi, Susono-shi (JP); Tatsuya Saito, Susono-shi (JP)

(73) Assignee: TOYOTA JIDOSHA KABUSHIKI KAISHA, Toyota-shi, Aichi (JP)

(21) Appl. No.: 13/978,461

(22) PCT Filed: Feb. 3, 2011
(86) PCT No.: PCT/JP2011/052268

§ 371 Date: Jul. 5, 2013

(51) Int. Cl. F16H 9/18

(52) U.S. Cl. CPC F16H 9/18
USPC 474/8

(57) ABSTRACT

A belt-driven continuously variable transmission includes a drive pulley, a driven pulley and a driving belt. Each pulley is formed by a fixed sheave integrated with a rotary shaft and a movable sheave fitted onto the rotary shaft in a slidable manner. A belt groove holding a driving belt is formed individually between conical surfaces of the fixed sheave and the movable sheaves being opposed to each other. The belt-driven continuously variable transmission changes a speed ratio continuously by altering an effective diameter of the driving belt by varying the groove width. A non-metallic belt made of resin material is used as the driving belt, and a friction coefficient of a radially inner region of each conical surface of driven pulley is smaller than that in a radially outer region.

### TECHNICAL FIELD

The present invention relates to a belt-driven continuously variable transmission for transmitting power through a driving belt applied between a drive pulley and a driven pulley, while varying a speed ratio steplessly by continuously varying an effective diameter position of the driving belt.

### BACKGROUND ART

The belt-driven continuously variable transmission of this kind is adapted to transmit power by a frictional force between the driving belt and the pulleys holding the driving belt therebetween. The belt-driven continuously variable transmission thus structured changes a speed ratio thereof continuously by varying a groove width between a drive pulley and a driven pulley thereby altering the effective diameter position of the driving belt. The driving belts are categorized into a metal belt formed by fastening a plurality of metal pieces called an element or a block by a steel belt, and a nonmetallic belt formed mainly of rubber or resin.

Generally, the pulley are made of metal material such as steel, cast iron or aluminum alloy etc., therefore, a contact point (i.e., a friction point) between the metal belt and the pulley has to be lubricated to prevent a galling or seizing at the contact point. For this reason, the metal belt is categorized into wet-type driving belts.

Meanwhile, the nonmetallic belt is made of rubber or resin material, and brought into contact with the metal pulleys to transmit the power frictionally. Therefore, a contact point between the nonmetallic belt and the pulley is not necessary to be lubricated. For this reason, the nonmetallic belt is called a dry-type driving belt. However, a friction coefficient of the nonmetallic belt is larger than that of the metal band. Therefore, if the nonmetallic belt thus structured is used in the continuously variable transmission, it is difficult or impossible to carry out a speed change operation under the situation that rotational speeds of the pulleys are low or the pulleys are not rotated.

For example, Japanese Patent Laid-Open No. 2004-116536 discloses a belt-driven continuously variable transmission using such a nonmetallic belt. According to the teachings of Japanese Patent Laid-Open No. 2004-116536, a nonmetallic belt is applied between a drive pulley and a driven pulley, and the continuously variable transmission is provided with a transmission motor for changing a groove width of the drive pulley. Specifically, a continuous current motor (i.e., a DC motor) is used as the transmission motor, and rotation property thereof such as a rotational speed and a rotational efficiency is changed depending on a rotational direction thereof. That is, the rotational speed of the transmission motor when increasing the speed ratio of the transmission is faster than the rotational speed when reducing the speed ratio of the transmission. In other words, the transmission motor is adapted to carry out a decelerating operation promptly. Therefore, in case a vehicle running at high speed is decelerated abruptly, the speed ratio of the continuously variable transmission taught by Japanese Patent Laid-Open No, 2004-116536 can be returned to the low speed side quickly. For this reason, according to the teachings of Japanese Patent Laid-Open No. 2004-116536, restartability of the vehicle is improved.

Meanwhile, Japanese Patent Laid-Open No. 2001-65651 discloses a belt driven continuously variable transmission using a metal belt. According to the teachings of Japanese Patent Laid-Open No. 2001-65651, in a pulley connected with an input shaft, a friction coefficient of a surface in an inner circumferential area is larger than the remaining area. Therefore, when the belt is displaced to the Low speed side, abrasion of elements of the metal belt is reduced.

As described, the friction coefficient of the nonmetallic belt is larger than that of the metal belt. Therefore, in case of using the nonmetallic belt in the belt-driven continuously variable transmission, a slippage between the nonmetallic belt and the pulleys may be reduced in comparison with the case of using the metallic belt. In this case, however, a speed change operation cannot be carried out if the pulleys are not rotated. Therefore, according to the teachings of Japanese Patent Laid-Open No. 2004-116536, the transmission motor is adapted to accelerate a decelerating operation thereby returning the speed ratio of the continuously variable transmission to the low speed side quickly in case of abruptly stopping the vehicle running at high speed. In this situation, however, energy has to be consumed excessively to increase the rotational speed of the transmission motor. As a result, fuel economy of the vehicle may be degraded. In addition, a thrust force for changing a groove width of the pulleys may be increased excessively large with an increase in a rotational speed of a speed change motor, and a durability of the driving belt may be degraded by the clamping force thus increased excessively.

As also described, according to the belt driven continuously variable transmission taught by Japanese Patent laid-Open No. 2001-65651, abrasion of elements of the metal belt is reduced in the Low speed side of input side pulley at which a contact pressure between and the metal belt and the surface of the pulley is the largest.

### DISCLOSURE OF THE INVENTION

In order to solve the foregoing technical problems, it is an object of this invention to provide a belt-driven continuously variable transmission which can carry out a speed change operation even if a rotation of a pulley comes to stop as a result of stopping the vehicle, and to improve a shift speed and durability of the belt-driven continuously variable transmission.

A belt-driven continuously variable transmission of the present invention is comprised of a drive pulley and a driven pulley, and a driving belt. Each pulley is formed by a fixed sheave integrated with a rotary shaft and a movable sheave fitted onto the rotary shaft in a slidable manner. A belt groove for holding a driving belt is formed between conical surfaces of the fixed sheave and the movable sheaves being opposed to each other. The belt-driven continuously variable transmission thus structured is allowed to change a speed ratio thereof continuously by altering an effective diameter position of the driving belt by moving the movable sheave in an axial direction of the rotary shaft to vary a width of the belt groove. According to the present invention, a non-metallic belt made of resin material is used as the driving belt. In addition, in the driving pulley, a friction coefficient of a radially inner region of the conical surface of the fixed sheave is smaller than that in a radially outer region, and a friction coefficient of a radially inner region of the conical surface of the movable sheave is also smaller than that in a radially outer region.

According to the present invention, the above-mentioned radially outer region is made of metal material, and the above-mentioned radially inner region is made of synthetic resin material.

In addition, a plurality of slits are formed on each of said conical surface from the radially inner side toward the radially outer side, or a surface treatment to increase roughness of the tapered face is applied gradually or stepwise from the radially inner side toward the radially outer side.

Specifically, according to the present invention, the surface treatment includes a coating and an etching.

In addition, the non-metallic belt includes a combined belt a torque transmitting capacity thereof is enhanced by attaching a plurality of metal blocks to the non-metallic belt.

Thus, in the driven pulley, the friction coefficient in the radially inner region of each conical surface of the driven pulley is smaller than that in the radially outer region. According to the present invention, therefore, the driving belt is allowed to slide on the conical surfaces of the driven pulley from the radially inner region toward the radially outer region, even if a rotation of the driven pulley comes to stop while leaving the driving belt in the radially inner region. That is, the belt-driven continuously variable transmission thus using the non-metallic driving belt is allowed to carry out a downshifting to increase the speed ratio by sliding the driving belt outwardly from the radially inner region of the driven pulley, even if the pulleys are not rotated. In other words, the driving belt is allowed to be returned to the radially outer region in the driven pulley. Moreover, since the driving belt is allowed to slide on the conical surfaces of the driven pulley from the radially inner side toward the radially outer side, a downshifting speed can be increased and the thrust force applied to the movable sheave to carry out a downshifting can be reduced. In addition, since the thrust force applied to the movable sheave can be reduced, durability of the driving belt as well as the belt-driven continuously variable transmission can be improved. In contrast, the friction coefficient in the radially outer regions of each conical surface of the driven pulley is higher than that in the radially inner region. Therefore, a required torque transmitting capacity can be ensured even if the driving belt is displaced to the radially outer region to increase the speed ratio. In addition, a slippage of the driving belt can be prevented in the radially outer region of the driven pulley. Therefore, when transmitting torque using the radially outer region of the driven pulley, the torque can be transmitted efficiently while pushing the movable shave by the reduced thrust force, in comparison with the case of transmitting torque using the radially inner region. Thus, the thrust force applied to the movable sheave of the driven pulley can be reduced.

As described, in the driven pulley, the radially outer region of each conical surface is made of metal material, and the radially inner region of each conical surface is made of synthetic resin material. Therefore, in addition to the foregoing advantages, the friction coefficient in the radially inner region can be reduced to be smaller than that in the radially outer region. Since the different materials are thus used to form the radially inner region and the radially outer region, the friction coefficient can be differentiated arbitrarily in those regions of the driven pulley.

In addition to the foregoing advantages, according to the present invention, the friction between the driving belt and the conical surface of the driven pulley can be increased from the radially inner region toward the radially outer region stepwise or gradually.

Specifically, the roughness of the conical surfaces of the driven pulley can be increased from the radially inner region toward the radially outer region stepwise or gradually, by a conventional method such as the a coating and the etching.

As also described, according to the present invention, the combined belt formed by attaching a plurality of metal blocks to the non-metallic belt may also be used as the driving belt. In addition to the foregoing advantages, the combined belt thus structured is also allowed to slide on the conical surfaces of the driven pulley from the radially inner region toward the radially outer region. Therefore, the combined belt is also allowed to be returned smoothly to the radially outer region in the driven pulley. For this reason, a downshifting speed can be increased and the thrust force applied to the movable sheave to carry out a downshifting can be reduced even if the combined belt is used in the belt-driven continuously variable transmission. In addition, since the thrust force applied to the movable sheave can be reduced, durability of the combined belt as well as the belt-driven continuously variable transmission can be improved.

### BRIEF DESCRIPTION OF THE DRAWINGS

FIG. 1 is a view showing a preferred example of the conical surface of the fixed sheave of the driven pulley according to the present invention.

FIG. 2 is a view showing the belt-driven continuously variable transmission of the present invention in which the speed ratio thereof is reduced.

FIG. 3 is a view showing the belt-driven continuously variable transmission of the present invention in which the speed ratio thereof is increased.

FIG. 4 is a view schematically showing a preferred example of the belt-driven continuously variable transmission according to the present invention.

### BEST MODE FOR CARRYING OUT THE INVENTION

Next, a preferred example of the present invention will be explained hereinafter. The present invention relates to a belt-driven continuously variable transmission adapted to change a speed ratio continuously by altering an effective diameter position of a driving belt running on a drive pulley and a driven pulley. In the belt-driven continuously variable transmission, the effective diameter position of the driving belt is displaced by altering a width of a V-shaped groove (as will be called a belt groove hereinafter) formed between sheaves of each pulley. Each drive and driven pulley is comprised of a pair of sheaves (or discs), and the belt groove is formed between conical inner surfaces of those sheaves opposed to each other. One of those sheaves is integrated with a rotary shaft (i.e., a pulley shaft) to serve as a fixed sheave, and the other sheave is fitted onto the rotary shaft in a slidable manner to serve as a movable sheave. Specifically, the movable sheave is allowed to move toward the fixed sheave and withdrawn away from the fixed sheave.

For example, a metal belt (also called a wet-type belt) is formed by fastening a plurality of metal pieces called an element or a block by a steel band in a circular manner. Meanwhile, a combined belt (also called a dry-type belt) is formed by combining a non-metallic belt made of resin or rubber with a plurality of metal pieces to enhance a torque transmitting capacity higher than that of the non-metallic belt. According to the present invention, both of the metal belt and the combined belt (or dry-combined belt) may be used as the driving belt of the continuously variable transmission.

According to the present invention, the radially inner region of the conical surface of each sheave of the driven pulley is made of synthetic resin, and the radially outer region of the conical surface of each sheave of the driven pulley is made of metal material. That is, in the driven pulley, the friction coefficient in the radially inner region of the conical surface of each sheave is reduced to be smaller than that in the radially outer region. The friction coefficient of the conical surface can be differentiated also by forming a plurality of slits radially on the conical surface, or by increasing roughness of the conical surface from the radially inner side toward the radially outer side gradually or stepwise. Consequently, in the driven pulley, friction acting between the driving belt and the conical surface of the sheave becomes smaller in the radially inner region than the radially outer region. For this purpose, the friction coefficient of the radially outer region of the conical surface can be altered by a conventional method such as a coating, an etching, a shotblasting and etc.

Thus, in the driven pulley, the friction coefficient in the radially inner region of the conical surface of each sheave is smaller than that in the radially outer region. In other words, in the radially inner region of the driven pulley, the friction acting between the driving belt and the conical surface of the sheave is smaller than that in the radially outer region. Therefore, in the driven pulley of the belt-driven continuously variable transmission, the driving belt is allowed to slide on the conical surface from the radially inner region toward radially outer region by pushing the movable sheave toward the fixed sheave when increasing the speed ratio toward a maximum ratio to start the vehicle, even if the driven pulley is not rotated or rotated at low speed. Optionally, in the radially inner region of the conical surface thus made of resin material, the friction coefficient thereof may also be differentiated between a circumferential direction (i.e., a rotational direction) and the radial direction.

As described, in the driven pulley, the driving belt is brought into contact with the radially outer region of the conical surface to increase the speed ratio toward the maximum ratio to start the stopping vehicle. For this purpose, in the driven pulley, the friction coefficient of the radially outer region of the conical surface of each sheave is determined in a manner to ensure the torque transmitting capacity possible to start the stopping vehicle when the speed ratio is increased to near the maximum ratio.

Meanwhile, a structure of the drive pulley is similar to that of conventional one. Specifically, the drive pulley is adapted to reduce the effective diameter of the driving belt held therein when the vehicle is stopped or decelerated abruptly, in preparation for increasing the speed ratio to restart or accelerate the stopped or decelerated vehicle.

According to the present invention, therefore, the belt-driven continuously variable transmission thus structured is allowed to carry out a downshifting by sliding the driving belt outwardly from the radially inner region of the driven pulley, even if the vehicle running at high speed is stopped abruptly so that the pulley comes to stop while leaving the driving belt within the radially inner region of the driven pulley. That is, in this situation, the speed ratio of the continuously variable transmission can be increased to the maximum ratio or near the maximum ratio possible to start the stopped vehicle without rotating the pulleys. In addition, the downshifting can be quickened by thus sliding the driving belt radially within the radially inner region of the driven pulley. Further, since the driving belt is allowed to slide radially within the radially inner region of the driven pulley, a thrust force for pushing the movable sheave can be reduced. Consequently, durability of the driving belt as well as the belt-driven continuously variable transmission is improved.

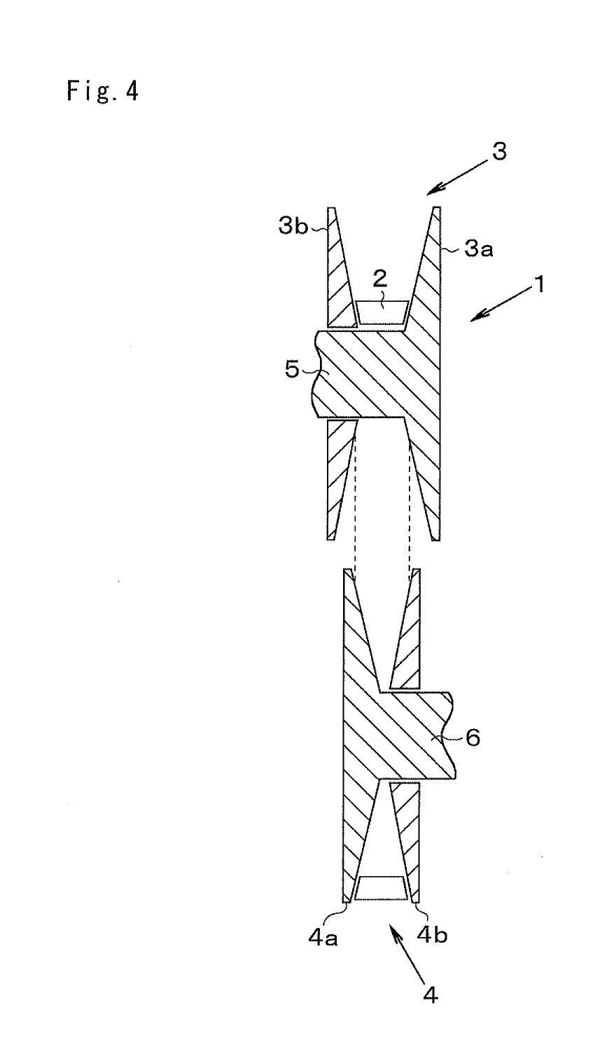

Refereeing now to FIG. 4, there is shown a preferred example of the belt-driven continuously variable transmission 1 according to the present invention. As shown in FIG. 4, the belt-driven continuously variable transmission 1 is comprised of: a drive pulley 3; a driven pulley 4; and a driving belt 2 applied to those pulleys 3 and 4. The drive pulley 3 is formed by a pair of fixed sheave 3a and movable sheave 3b, and the driven pulley 4 is formed by a pair of fixed sheave 4a and movable sheave 4b. The fixed sheave 3a and the movable sheave 3b are individually provided with a conical surface on its inner faces being opposed to each other, and also, the fixed sheave 4a and the movable sheave 4b are individually provided with a conical surface on its inner faces being opposed to each other. Therefore, a belt groove is formed in the drive pulley 3 between the conical surfaces of the sheaves 3a and 3b, and a belt groove is also formed in the driven pulley 4 between the conical surfaces of the sheaves 4a and 4b. In the drive pulley 3 and the driven pulley 4 thus structured, an effective diameter position of the driving belt 2 interposed between the sheaves 3a and 3b, and an effective diameter position of the driving belt 2 interposed between the shaves 4a and 4b are individually altered by changing widths of the belt grooves of pulleys 3 and 4.

Although not especially shown in the accompanying figures, the driving belt 2 is a combined belt comprised of a plurality of metal blocks contacted to the belt grooves of the pulleys 3 and 4 while withstanding a lateral pressure from the sheaves, and a resin band fastening those blocks in a circular manner.

Specifically, the block is a metal plate member made of steel, aluminum alloy etc. and covered with a resin. Alternatively, the driving belt 2 may also be formed by combining blocks made of high-strength synthetic resin integrally with a resin band. In addition, both width ends of the block are tapered to be contacted with the belt grooves of the pulleys 3 and 4.

In the preferred example shown in FIG. 4, a positional relation between the fixed sheave 3a and the movable sheave 3b is opposite to that between the fixed sheave 4a and the movable sheave 4b. However, fundamental structures of the drive pulley 3 and the driven pulley 4 are identical to each other. Hereinafter, the structures of the drive pulley 3 and the driven pulley 4 will be explained in more details. The fixed sheave 3a is integrated with a pulley shaft (i.e., a rotary shaft) 5 extending toward the movable sheave 3b, and the movable sheave 3b is fitted onto the pulley shaft 5 while being allowed to reciprocate in the axial direction of the pulley shaft 5. Accordingly, the conical surfaces of the fixed sheave 3a and the movable sheave 3b are opposed to each other. Likewise, the fixed sheave 4a is integrated with a pulley shaft (i.e., a rotary shaft) 6 extending toward the movable sheave 4b, and the movable sheave 4b is fitted onto the pulley shaft 5 while being allowed to reciprocate in the axial direction of the pulley shaft 6. Accordingly, the conical surfaces of the fixed sheave 4a and the movable sheave 4b are opposed to each other.

In order to apply a pushing force to the movable shave 3b toward the fixed sheave 3a, a not shown thrust generator is arranged behind the movable sheave 3b. Likewise, in order to apply a pushing force to the movable shave 4b toward the fixed sheave 4a, a not shown thrust generator is arranged behind the movable sheave 4b. For example, an electric actuator and a hydraulic actuator may be used as the thrust generators. Thus, a clamping force for clamping the driving belt 2 between the sheaves 3a and 3b, and a clamping force for clamping the driving belt 2 between the sheaves 4a and 4b are controlled by altering the pushing force of those thrust generators.

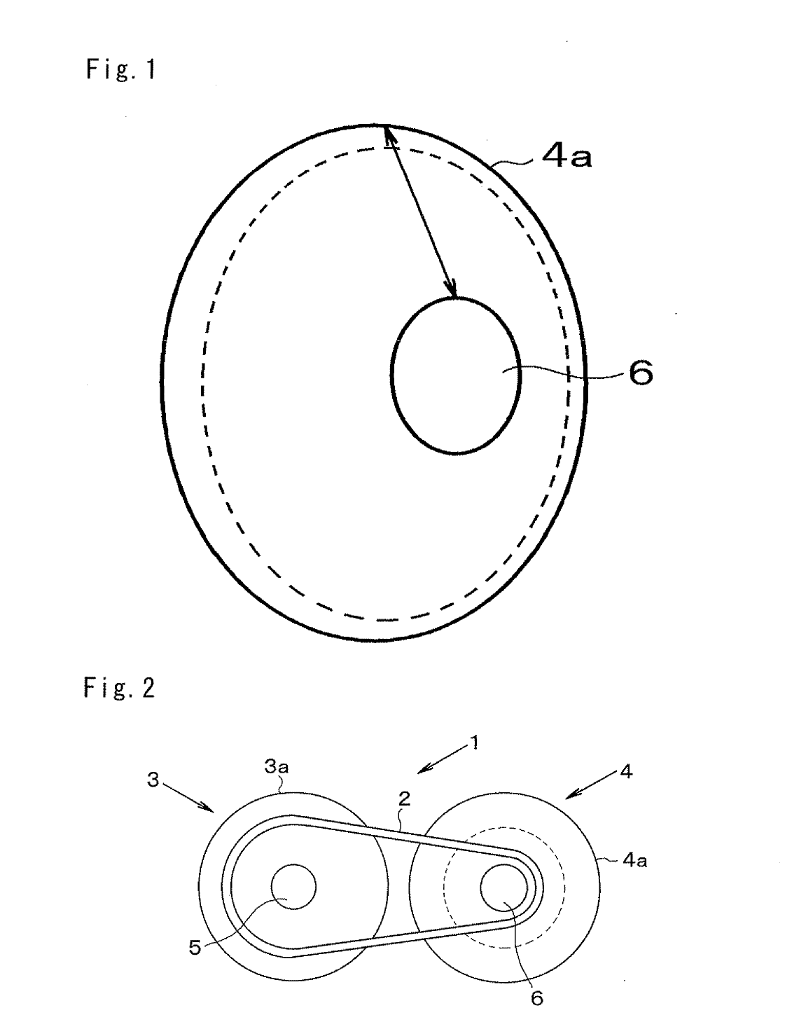

Referring now to FIG. 1, there is shown a preferred example of the conical surfaces of the driven pulley 4. In FIG. 1, only the conical surface of the fixed sheave 4a is illustrated for the sake of convenience, however, a structure of the conical surface of the fixed sheave 4a and a structure of the conical surface of the movable sheave 4b are fundamentally similar to each other. In the fixed sheave 4a shown in FIG. 1, the radially inner region of the conical surface is made of synthetic resin material so that a friction coefficient in the radially inner region is reduced to be smaller than that in the radially outer region. Alternatively, the friction coefficient in the radially inner region of the conical surface may be reduced to be smaller than that in the radially outer region by increasing roughness of the conical surface from the radially inner side toward the radially outer side gradually or stepwise. For example, the friction coefficient in the radially inner region of the conical surface may be reduced by forming a plurality of slits on the conical surface radially from the inner region toward the outer region. In addition, the friction coefficient of the radially inner region of the conical surface may also be reduced by a conventional method such as a coating, an etching, a shotblasting etc. In the driven pulley 4, therefore, a friction between the driving belt 2 and the radially inner region of each conical surface is smaller in comparison with that between the driving belt 2 and the radially outer region of each conical surface.

In the driven pulley 4, the driving belt 2 is brought into contact with the radially outer regions of the conical faces of the sheaves 4a and 4b when starting the stopping vehicle by increasing the speed ratio of the belt-driven continuously variable transmission 1 toward the maximum ratio. Therefore, the radially outer regions of the conical faces of the sheaves 4a and 4b are made of conventional metal material to ensure a torque transmitting capacity required to start the stopping vehicle.

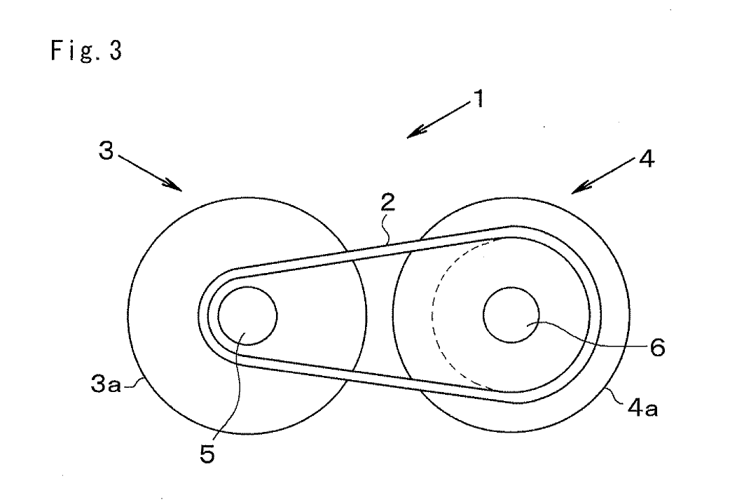

Next, functions of the belt-driven continuously variable transmission 1 will be explained hereinafter. FIG. 2 shows the belt-driven continuously variable transmission 1 setting a small speed ratio. When the speed ratio is reduced as illustrated in FIG. 2, that is, when increasing the input speed of the belt-driven continuously variable transmission 1, the movable sheave 3b of the drive pulley 3 is pushed toward the fixed sheave 3a thereby narrowing the belt groove therebetween to increase the effective diameter of the driving belt 2. Consequently, a part of the driving belt 2 is pulled in the driven pulley 4 while widening the belt groove and shrinking the effective diameter thereof.

Thus, when the belt-driven continuously variable transmission 1 increases the input speed, the driving belt 2 in the driven pulley 4 is brought into contact with the radially inner region of each conical face where the friction coefficient is smaller than that in the radially outer region. In this situation, the movable sheave 4b pushes the driving belt 2 in the belt groove of the driven pulley 4 by a pushing force which does not to cause a slippage of the driving belt 2. Meanwhile, in the drive pulley 3, the driving belt 2 is clamped by the sheaves 3a and 3b under a degree of pressure not to change the effective diameter position of the driving belt 2 in the driven pulley 4.

When the vehicle thus running under the small speed ratio is decelerated abruptly or stopped abruptly, the speed ratio of the belt-driven continuously variable transmission 1 is increased for the preparation of restarting the vehicle. That is, a downshifting is carried out. Specifically, in the drive pulley 3, the pushing force applied to the movable sheave 3b is reduced to withdraw the movable sheave 3b away from the fixed sheave 3a. Consequently, the driving belt 2 in the drive pulley 3 is displaced inwardly while widening the belt groove of the drive pulley 3. As a result, the effective diameter of the driving belt 2 in the drive pulley 3 is reduced.

In this situation, in the driven pulley 4, a pushing force is applied to the movable sheave 4b to push the movable sheave 4b toward the fixed sheave 4a thereby narrowing the belt groove of the driven pulley 4. As described, in the driven pulley 4, the friction coefficient of the radially inner region of the conical surface of each shaves 4a and 4b is reduced to be smaller than that in the radially outer region. In this situation, therefore, the driving belt 2 is allowed to slide on the conical surface from the radially inner region toward the radially outer region to increase the effective diameter thereof in the driven pulley 4, by merely pushing the movable sheave 4b toward the fixed sheave 4a. That is, the driving belt 2 is allowed to slide on the conical surface outwardly from the inner region to increase the effective diameter thereof by pushing the movable sheave 4b toward the fixed sheave 4a, even when the driven pulley 4 is stopped or rotated at extremely low speed.

Referring now to FIG. 3, there is shown the belt-driven continuously variable transmission 1 setting a large speed ratio. When the speed ratio is increased as illustrated in FIG. 3, that is, when decreasing the input speed of the belt-driven continuously variable transmission 1, the driving belt 2 in the driven pulley 4 is brought into contact with the radially outer regions of conical surfaces of the sheaves 4a and 4b where the friction coefficient is individually larger than that in the radially inner region. Therefore, the driving belt 2 is thus brought into contact with the radially outer regions of the conical surfaces of the sheaves 4a and 4b when increasing the speed ratio toward the maximum ratio possible to start the vehicle. For this purpose, when the input speed of the belt-driven continuously variable transmission 1 is thus decreased to start the vehicle, the driving belt 2 in the driven pulley 4 is clamped by the fixed sheave 4a and the movable sheave 4b under a degree of pressure not to cause a slippage of the driving belt 2. Meanwhile, in the drive pulley 3, the driving belt 2 is clamped by the sheaves 3a and 3b under a degree of pressure not to change the effective diameter position of the driving belt 2 in the driven pulley 4.

According to the belt-driven continuously variable transmission 1 thus structured, the combined belt is used as the driving belt 2, and the effective diameter of the driving belt 2 can be expanded in the driven pulley 4 smoothly when the running vehicle is decelerated or stopped abruptly. Therefore, a downshifting of the belt-driven continuously variable transmission 1 is allowed to carry out a downshifting promptly. That is, the belt-driven continuously variable transmission 1 is allowed to increase the speed ratio promptly to start the vehicle smoothly, even when the driven pulley 4 comes to stop or rotated at extremely low speed while leaving the driving belt 2 within the radially inner region as illustrated in FIG. 2. In addition, since the driving belt 2 is allowed to slide on the radially inner region of the conical surface, the thrust force required for pushing the movable sheave 4b to carry out a speed change operation can be reduced. Therefore, the durability of the driving belt 2 as well as the belt-driven continuously variable transmission can be improved. In contrast, in the radially outer regions of the conical surfaces of the shaves 4a and 4b, the friction coefficient is individually higher than that in the radially inner region. Therefore, a required torque transmitting capacity to start the vehicle can be ensured. That is, a friction between the driving belt 2 and the radially outer region of the shaves 4a or 4b is higher than that between the driving belt 2 and the radially outer region. Therefore, when the driving belt 2 is situated in the radially outer region of the driven pulley 4, the thrust force for pushing the movable sheave 4b can be reduced in comparison with the case in which the driving belt 2 is situated in the radially inner region. For this reason, the thrust force for pushing the movable sheave 4b may also be reduced when the driving belt 2 is thus situated in the radially outer region in the driven pulley 4, and the torque can be transmitted efficiently within the radially outer region of the driven pulley 4 in comparison with the case of transmitting torque using the radially inner region of the driven pulley 4. Thus, the thrust force applied to the movable sheave 4b of the driven pulley 4 can be reduced.

1. A belt-driven continuously variable transmission, comprising:
a drive pulley and a driven pulley, each of which is formed by a fixed sheave integrated with a rotary shaft and a movable sheave fitted onto the rotary shaft in a slidable manner;
a belt groove holding a driving belt formed between conical surfaces of the fixed sheave and the movable sheaves being opposed to each other; and
wherein the belt-driven continuously variable transmission is adapted to change a speed ratio continuously by altering an effective diameter position of the driving belt by moving the movable sheave in an axial direction of the rotary shaft to vary a width of the belt groove;
wherein the driving belt includes a non-metallic belt made of resin material;
wherein a friction coefficient of a radially inner region of each conical surface of the driven pulley is smaller than that in a radially outer region, and
wherein the radially outer region is made of metal material, and the radially inner region is made of synthetic resin material.

2. The belt-driven continuously variable transmission as claimed in claim 1, wherein the friction coefficient in the radially inner region made of synthetic resin material is differentiated between a circumferential direction and the radial direction.

3-4. (canceled)

5. The belt-driven continuously variable transmission as claimed in claim 1, wherein the non-metallic belt includes a combined belt a torque transmitting capacity thereof is enhanced by attaching a plurality of metal blocks to the non-metallic belt.
